(19) United States
(12) Patent Application Publication
(10) Pub. No.: US 2023/0132778 A1
(43) Pub. Date: May 4, 2023

(54) SHARED SERVICE MANAGEMENT SYSTEM THROUGH USER UNIQUE IDENTIFICATION KEY REGISTRATION AND AUTHENTICATION

(71) Applicant: Sok Chan YUN, Gyeonggi-do (KR)

(72) Inventor: Sok Chan YUN, Gyeonggi-do (KR)

(21) Appl. No.: 17/915,261

(22) PCT Filed: Jul. 12, 2021
(86) PCT No.: PCT/KR2021/008870

§ 371 Date: Sep. 28, 2022

(30) Foreign Application Priority Data
Aug. 19, 2020 (KR) 10-2020-0103787

(51) Int. Cl. H04L 9/40; G07C 9/00

(52) U.S. Cl. CPC H04L 63/083; H04L 63/102; G07C 9/00309; G07C 2009/00769

(57) ABSTRACT

A shared service management system includes an operator terminal, a user terminal, a shared object including a locking device, and a smart lock module capable of receiving a user's user unique identification key and unlocking the locking device, and a shared service management server configured to match and register data of the shared object according to the user's application for use and the user's user unique identification key, receive the user unique identification key, from the smart lock module when the user attempts to access and use the shared object, determine whether the user is a user approved for use on the basis of the user unique identification key, and transmit a user matching signal to the smart lock module on the basis of the determination result, wherein the smart lock module controls unlocking of the locking device on the basis of the user matching signal.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2021/008870 filed on Jul. 12, 2021, which claims priority to the benefit of Korean Patent Application No. 10-2020-0103787 filed in the Korean Intellectual Property Office on Aug. 19, 2020, the entire contents of which are incorporated herein by reference.

### BACKGROUND

### 1. Technical Field

The present invention relates to a shared service management system through registration and authentication of a user's unique identification key, and more particularly, to a shared service management system through registration and authentication of a user's unique identification key, which functions as a mediator in a shared service such as a hotel, an office, a work place, mobility, or the like so that a user may use a plurality of shared services through his or her own identification key.

### 2. Background Art

Recently, according to the boom in sharing economy, the concept of shared services is introduced in the offices, general houses, apartments, shopping malls, and the like, which have been recognized as long-term rentals, as well as in real estate for short-term rental purposes, such as hotels and lodging houses. The boom in the sharing economy has spread to the field of mobility, such as vehicles, bicycles, kickboards, and the like, and informs arrival of MaaS

(Mobility as a Service) era. In addition, various attempts for sharing or dividing underutilized resources are made in various fields.

As if reflecting the stream of times, a plurality of operation subjects pursuing the sharing economy emerges for each service in each field. However, as the plurality of operation subjects provides shared services through different platforms, customers inevitably suffer from inconvenience of separately joining each platform. In particular, inconvenience is unavoidable since the customers should receive a separate identification key for each use target or use several identification keys for each platform.

Meanwhile, in the method of using the shared services, it is general that services are provided in a way that a user make a reservation for a use target online or by wire, and an operator (administrator) or an owner provides an identification key of the use target to the user on the premise of prepayment or post-payment.

That is, in a conventional method familiar to the public, it is general that a physical key (e.g., a key, an access (identification) card) is handed over to the user as an identification key, or a password is informed to use when a locking device having a keypad is installed. However, in recent days, instead of using a physical key or inputting a password, a system (keyless system) that controls opening and closing of a locking device using a smart phone is applied.

Korean Registered Patent Nos 10-1509079, 10-1690010, 10-1661478, 10-1875725 and Korean Patent Publication 10-2018-0072652 are examples of the keyless system, and a system common the examples may be summarized as shown in FIG. 1. Referring to FIG. 1, a conventional keyless system is shown. An operator manages a unique password (identification code) of a control module that controls the locking module of a use target operated by the operator, and registers and manages a unique password (identification code) corresponding to each use target in a shared service server.

Then, a customer accesses the shared service server through a web, an app, or a web app of a customer terminal, applies for using a use target, and receives a unique password of the use target and an approved period data from the shared service server after making a payment and receiving an approval for using the target. Thereafter, the user may use the use target by controlling the control module to unlock the locking module of the use target through short-range communication (NFC, Bluetooth, etc.) with the control module of the use target using a smartphone (customer terminal) within the approved period.

That is, the keyless system described above is different from the conventional method familiar to the public only in that the step of providing a physical key or a password is omitted, and the locking device is unlocked using a smartphone, and internally, the concept of receiving an identification key for each use target and using a service is the same as that of the conventional method. That is, although the keyless system is applied, the inconvenience of customers having to separately join each platform and the inconvenience of receiving a unique identification key (unique password) for each use target or using several identification keys, which have been a problem in the past, still remain. Moreover, such a system has a problem in that since one unique identification key is assigned to each use target, security is vulnerable when a corresponding identification key is hacked.

In addition, from the standpoint of operators who have provided shared services in a conventional method, although there is a need for adopting a keyless system in view of non-face-to-face issue and labor cost saving, it is very difficult from the aspect of cost since the dedicated lock module shown in FIG. 1 should be separately installed for each use target for conversion of the system.

### SUMMARY

Accordingly, the present invention has been made in view of the problems occurring in the prior art, and it is an object of the present invention to provide a shared service management system through registration and authentication of a user's unique identification key, in which a user may access various types of use targets only by joining one platform, and simultaneously use a plurality of use targets operated by different operation subjects by using one user's unique identification key without a separate information registration process.

To accomplish the above object, according to an aspect of the present invention, there is provided a shared service management system that allows a user to use a shared service using his or her own user's unique identification key, the system comprising: an operator terminal for registering at least one shared object; a user terminal of a user for applying for using a shared object and a period of using the shared object; at least one shared object that includes a locking device for restricting access or use of the user, and a smart lock module capable of receiving a user's unique identification key of the user from the user terminal through short-range communication and unlocking the locking device; and a shared service management server configured to register data on the shared object according to the user's application for using the shared object and the user's unique identification key by matching them each other, receive the user's unique identification key, which is received from the user terminal, from the smart lock module through the network, when the user attempts to access or use the shared object that the user has applied for through the user terminal, determine whether the corresponding user is a user allowed to use based on the user's unique identification key, and transmit a user matching signal to the smart lock module based on a result of the determination, wherein the smart lock module is configured to control locking and unlocking of the locking device based on the user matching signal of the shared service management server.

In an embodiment of the present invention, the data on the shared object may include a production module identification key of the smart lock module.

In an embodiment of the present invention, the production module identification key may be a serial number of a microcontroller (MCU) of the smart lock module.

In an embodiment of the present invention, when the user applies for using a specific shared object, the shared service management server may register data on the specific shared object and the user's unique identification key of the user by matching them each other on the premise of approval of the operator who provides a sharing service for the specific shared object.

In an embodiment of the present invention, the short-range communication may be at least one among RFID, NFC, and Bluetooth.

In an embodiment of the present invention, the smart lock module may notify, based on the user matching signal, whether or not the user matches to the user who attempts to access or use the shared object using the user terminal.

In an embodiment of the present invention, the user's unique identification key may be generated based on at least one among a unique password of the user and a serial code of the user terminal.

In an embodiment of the present invention, the smart lock module may be implemented as a Raspberry Pi.

In an embodiment of the present invention, the smart lock module may be designed to be compatible with the locking device of the shared object, and coupled to the locking device to lock or unlock the locking device.

In an embodiment of the present invention, the smart lock module may be formed to be integrated with the locking device of the shared object.

A shared service management system through registration and authentication of a user's unique identification key according to the present invention may provide users with convenience as a user may access various types of shared objects only by joining one platform, and simultaneously use a plurality of shared objects operated by different operation subjects by using one user's unique identification key without a separate information registration process.

In addition, an operation subject of the shared service does not need to separately manage a recognition key, such as unnecessarily assigning a temporary number or an identification key to a user, and the operation subject of the shared object to which an existing general electronic digital lock is applied may also adopt the keyless system at a comparatively low price.

### BRIEF DESCRIPTION OF THE DRAWINGS

FIG. 1 is a block diagram showing a conventional keyless system.

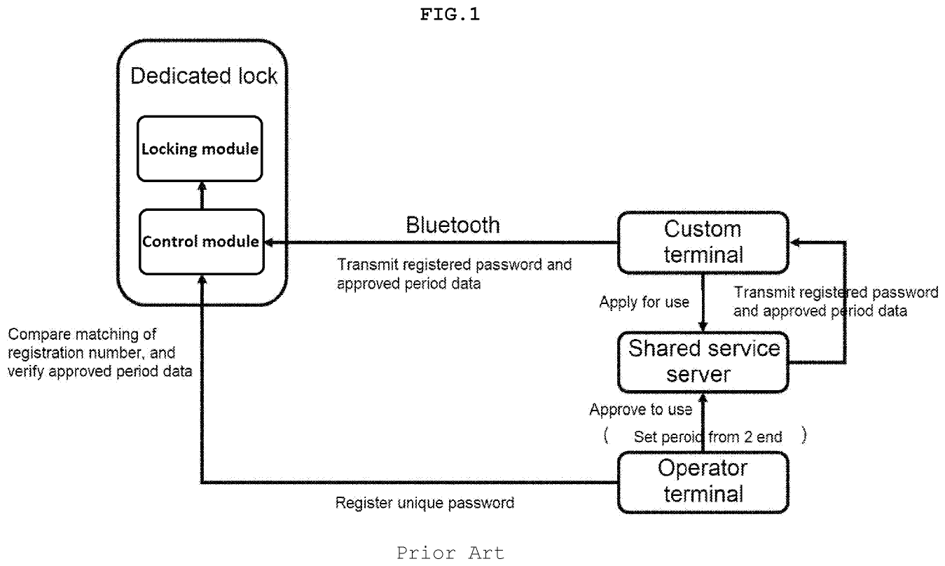

FIG. 2 is a block diagram showing a shared service management system according to an embodiment of the present invention.

FIG. 3 is a block diagram showing the smart lock module of FIG. 2.

FIG. 4 is a block diagram showing the shared service management server of FIG. 2.

FIG. 5 is a flowchart illustrating a process of using a shared service by a user through a shared service management system according to an embodiment of the present invention.

### DETAILED DESCRIPTION

Hereinafter, preferred embodiments of the present invention will be described in detail with reference to the accompanying drawings so that those skilled in the art may easily embody the present invention. However, the present invention may be implemented in various different forms and is not limited to the embodiments described herein. In addition, when reference numerals are assigned to the components in each drawing, the same reference numeral is given the same components although they are shown in different drawings. In addition, when a component is “connected” or “linked” to another component in this specification, this includes not only the cases where both components are “directly” connected, but also the cases where other components are interposed therebetween, and this also includes not only “physically” connected cases, but also “functionally or communicatively” connected cases. In addition, when a part “includes” a certain component, this means that other components may be further included, rather than excluding other components, unless stated otherwise.

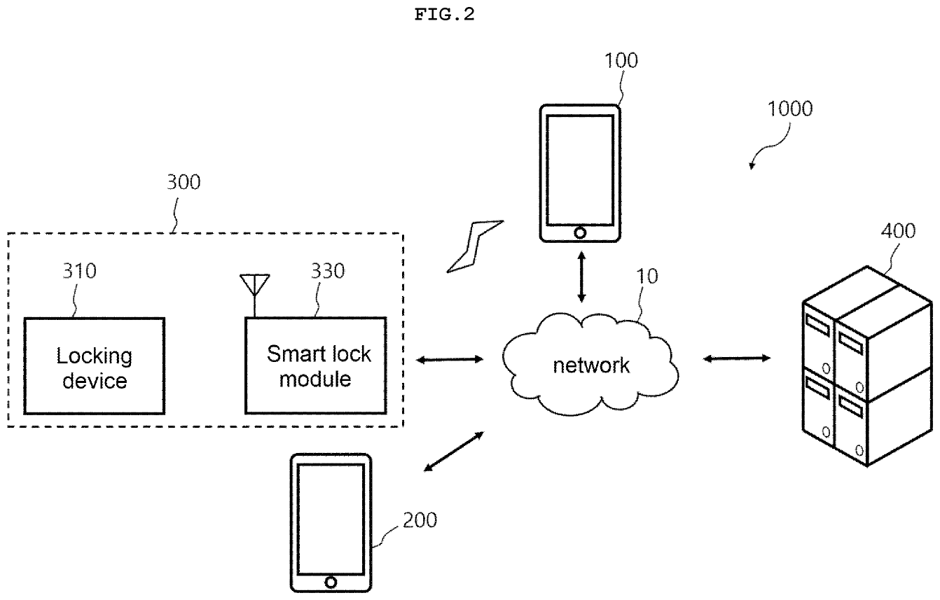

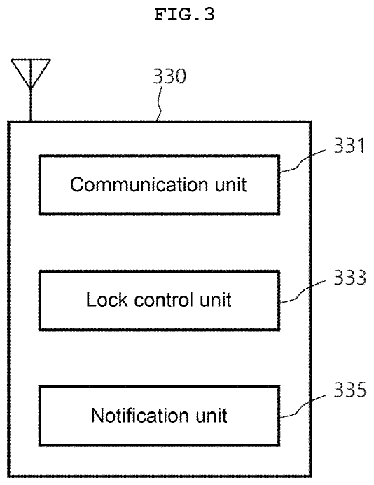

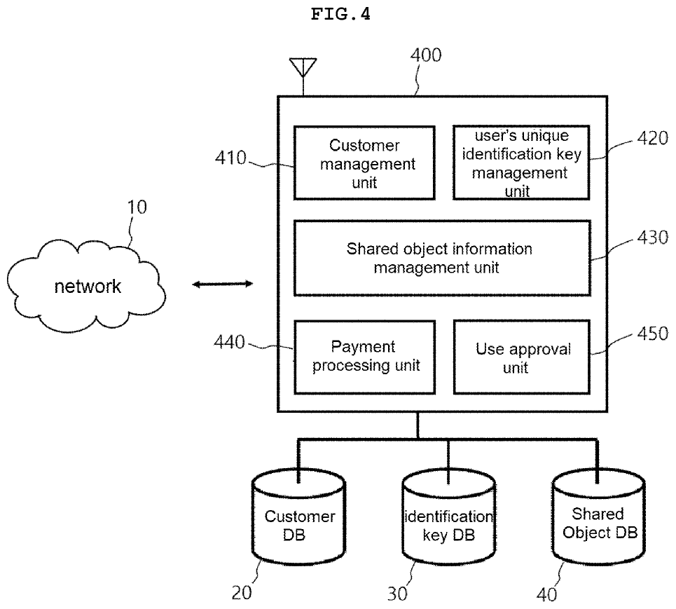

FIG. 2 is a block diagram showing a shared service management system according to an embodiment of the present invention. FIG. 3 is a block diagram showing the smart lock module of FIG. 2. FIG. 4 is a block diagram showing the shared service management server of FIG. 2.

Referring to FIGS. 2 to 4, a shared service management system 1000 of the present invention is configured to manage a plurality of users, who desires to use a shared service provided by at least one operator, to access or use at least one shared object using their own unique identification key. For example, the shared service management system 1000 may provide a shared service for a shared object registered by at least one operator, or provide a service in the form of mediating between the user and the operator in a form affiliated with shared services already operated by the operator.

The shared service management system 1000 includes a user terminal 100, an operator terminal 200 for operating shared services, a shared object 300, and a shared service management server 400 for registering data on the shared object 300 managed by the operator through the operator terminal 200, and allowing a user to register his/her own user's unique identification key through the user terminal 100, and use a specific shared object 300 through the user's unique identification key after making a payment for using the shared object.

The user terminal 100 is a computer or a portable terminal owned by an individual or a company (hereinafter, referred to as a ‘user’) who desires to use at least one shared object 300 or shared service through the shared service management system 1000, and is configured to allow the user to join as a new member or log in by communicating with the shared service management server 400 through the network 10 in the form of a web, an application, or a web app, create and register his or her own user's unique identification key, and use at least one shared object 300 through a payment. The payment is determined according to a selected shared object and a period of using the shared object, and the period of using the shared object may be set, for example, in units of years, months, days, hours, or minutes according to the characteristics of using the shared object.

In addition, the user terminal 100 may transmit the user's unique identification key through short-range communication with the shared object 300, and access or use the shared object 300 after being authenticated by the shared service management server 400. Here, the user's unique identification key may be sequentially assigned as the user inputs personal information in the shared service management server 400 and joins as a member, or may be generated based on user's unique information, for example, a user's unique password, a cellular phone number, or a serial code unique to the user terminal.

The operator terminal 200 is a computer or a portable terminal owned by an individual or a company (hereinafter, referred to as an ‘operator’) who desires to operate or jointly provide shared services for at least one shared object through the shared service management system 1000, and is configured to allow the operator to join as a new member or log in by communicating with the shared service management server 400 through the network 10 in the form of a web, an application, or a web app, input and register data on the shared object 300 that the operator desires to share, and approve a user to use the shared object when the user selects a specific shared object and a period of using the shared object.

The data on the shared object 300 may include general information on the shared object and a production module identification key of a smart lock module 330 described below included in the shared object, e.g., serial number information of a microcontroller unit (MCU). This is used as information for identifying the shared object 300 registered in the shared service management server 400, and in addition, when a user attempts to access or use a specific shared object, the data may be used to determine whether the user is a user allowed to use the shared object.

Here, the computer includes, for example, a desktop computer, a laptop computer, a tablet PC, and the like equipped with a web browser, and the portable terminal is a wireless communication device that guarantees portability and mobility, and may include all kinds of handheld-based wireless communication devices such as a smartphone, Personal Communication System (PCS), Global System for Mobile communication (GSM), Personal Digital Cellular (PDC), Personal Handyphone System (PHS), Personal Digital Assistant (PDA), International Mobile Telecommunication-2000 (IMT-2000), Code Division Multiple Access-2000 (CDMA-2000), WCode Division Multiple Access (W-CDMA), Wireless Broadband Internet (Wibro), and the like.

In addition, the network 10 connecting the user terminal 100 and the operator terminal 200 to the shared service management server 400 may be implemented as any type of wired/wireless network such as a Local Area Network (LAN), a Wide Area Network (WAN), a Value-Added Network (VAN), a Personal Area Network (PAN), a mobile radio communication network, Wireless Broadband Internet (Wibro), Mobile WiMAX, High Speed Downlink Packet Access (HSDPA), a satellite communication network, or the like.

The shared object 300 is a use target that the operator desires to share, and the shared object 300 includes real estate such as hotels, lodging houses, offices, general houses, apartments, and shopping malls, mobilities such as vehicles, bicycles, and kickboards, and other goods that can be shared with users through shared services. However, since it is assumed in the present invention that a locking device is installed as a means capable of restricting access or use of the shared object 300, the shared object 300 is limited to goods for which user's access or use can be restricted through the locking device. Specifically, the shared object 300 includes a locking device 310, and a smart lock module 330 configured to control locking and unlocking of the locking device 310.

The locking device 310 is a means coupled to or embedded in the shared object 300 to restrict user's access to or use of the shared object 300, and may be an electronic digital locking module. However, it is not limited thereto, and the locking device 310 may be a mechanical locking module.

The smart lock module 330 is configured to be connected to the locking device 310 to control locking and unlocking of the locking device 310. For example, the smart lock module 310 may be designed to be compatible with the locking device 310 and configured to be coupled to the locking device 310 that is configured separately. For example, the smart lock module 330 may be independently connected to the locking device 310 or may be embedded in the locking device 310. Meanwhile, the smart lock module 330 may be sold or provided by the manager of the shared service management system 1000, or may be designed to be applied to an existing locking device through purchase in the market. That is, the smart lock module 330 may function as Internet of Things (IoT). Alternatively, the smart lock module 330 may be formed to be integrated with the locking device 310.

In addition, the smart lock module 330 is configured to communicate with the user terminal 100 through short-range communication, and communicate with the shared service management server 400 through the network 10. In addition, the smart lock module 330 is configured to notify whether the user may use the shared object 300 through a notification according to a result of user authentication. For example, the smart lock module 330 may be implemented as a Raspberry Pi.

Specifically, the smart lock module 330 includes a communication unit 331, a lock control unit 333, and a notification unit 335.

The communication unit 331 is configured to use the network 10 or to support a short-range wireless communication method such as NFC, RFID, or Bluetooth. Specifically, the smart lock module 330 is configured to receive a user's unique identification key from the user terminal 100 using the short-range wireless communication of the communication unit 331, transmit the received user's unique identification key to the shared service management server 400 through the network 10, and receive whether the user matches from the shared service management server 400.

In addition, when the communication unit 331 receives the user's unique identification key from the user terminal 100, it also transmits a production module identification key, which is a unique identification key of the smart lock module 330, to the shared service management server 400 through the network 10. That is, the shared service management server 400 identifies a shared object that the user has attempted to access or use through the production module identification key, and determines whether the current user is a user allowed to use the shared object, i.e., whether the user matches.

The lock control unit 333 is configured to control locking and unlocking of the locking device 310. For example, locking and unlocking may be performed by a digital signal of the lock control unit 333 or performed by mechanical handling of the lock control unit 333. Specifically, the lock control unit 333 controls the locking device 310 to be unlocked when the user is confirmed as a user allowed to use according to whether the user matches that is received from the communication unit 331. In addition, alternatively, it is configured to maintain the locked state of the locking device 310 when the user is not allowed to use.

The notification unit 335 is configured to transmit a notification to the user according to whether the user matches that is received from the communication unit 331. For example, the notification unit 335 may be configured of a speaker to notify the user by voice through the speaker, or may be configured of a display exposed to the outside of the shared object 300 to visually notify the user through the display. Alternatively, the notification unit 335 may not be a means that directly transmits a notification, such as a speaker or a display, but may be a configuration that generate a notification signal to be transmitted through the communication unit 311 so that the user terminal 100 may transmit the notification.

Meanwhile, although it has been described as an example that when the smart lock module 330 according to this embodiment receives the user's unique identification key from the user terminal 100, the smart lock module 330 also transmits a production module identification key, which is a unique identification key of the smart lock module 330, to the shared service management server 400 through the network 10, and the shared service management server 400 determines, based on this, whether the user matches through the production module identification key and the user's unique identification key, it is not limited thereto. For example, it may be configured such that the shared service management server 400 transmits a user's unique identification key of a user allowed to use to the smart lock module 330 of a specific shared object identified using the production module identification key, and when the user's unique identification key is transmitted from the user terminal 100, the smart lock module 330 determines whether the user is a corresponding user and unlocks the locking device 310.

Accordingly, in the shared service management system 1000 according to the present invention, the operation subject of the shared service does not need to separately manage a recognition key, such as unnecessarily assigning a temporary number or an identification key to a user, and the operation subject of the shared object to which an existing general electronic digital lock is applied may also adopt the keyless system at a comparatively low price through the smart lock module capable of communicating with the system.

The shared service management server 400 is configured to communicate with the user terminal 100, the operator terminal 200, and the shared object 300 through the network 10, and when data on the shared object is registered by the operator and a specific shared object and a period of using the shared object are selected by the user, the shared service management server 400 allows the user to use the shared object. In addition, the shared service management server 400 is configured to determine, when the smart lock module 330 receives the user's unique identification key from the user terminal 100, whether the current user is a user allowed to use the shared object and transmit a result of matching the user to the smart lock module 330.

Hereinafter, the shared service management server 400 according to the present embodiment will be described in detail with reference to FIG. 4.

The shared service management server 400 includes a customer management unit 410, a user's unique identification key management unit 420, a shared object information management unit 430, a payment processing unit 440, and a use approval unit 450.

The customer management unit 410 registers and manages users who desire to use shared objects in the shared service management system 1000 and operators who desire to provide shared services for at least one shared object as customers. For example, the customer management unit 410 may include a user management module for storing and managing user registration information, and an operator management module for storing and managing operator registration information.

The user management module is configured to receive basic information such as the name, resident registration number, address, and contact information of a user input from the user terminal 100 or basic information of a company such as the name, business registration number, address, and contact information of the company, and store and manage the basic information in a customer DB 20, and is configured to accumulate information on the payment and use of shared objects that the user has applied to use, and store the accumulated information in the shared service management server 400.

The operator management module is configured to receive basic information such as the name, resident registration number, address, and contact information of an operator input from the operator terminal 200 or basic information of a company such as the name, business registration number, address, and contact information of the company, and store and manage the basic information in the customer DB 20, and is configured to store and manage, in the customer DB 20, information on the nature of shared objects registered in the shared service management server 400 by the operator, information on the list of treated shared objects, and information on whether the user is allowed to use according to the user's application for using the shared objects. In addition, a banking account number (name of a financial company, account holder) for receiving a profit generated by providing the shared service may be registered, stored, and managed in the customer DB 20.

In addition, an embodiment of the present invention has been described as an example that the customer management unit 410 stores and manages users and operators in the customer DB 20, the present invention is not limited thereto, and the users and operators may be managed through a separate DB. In addition, although this embodiment has been described as an example that the users and operators are classified and information thereon is managed in different modules, the present embodiment is not limited thereto. For example, the customer management unit 410 may register and integrally manage the customers without classification. In this case, when a user or an operator connects to and logs in the shared service management server 400, the customer management unit 410 confirms whether the connected person is a customer, and when it is confirmed that the person is a customer, the customer management unit 410 may switch the interfaces displayed on the user terminal 100 and the operator terminal 200 according to whether the connected person is a user or an operator so that a service corresponding thereto may be provided.

The user's unique identification key management unit 420 is configured to generate and manage a user's unique identification key for each user. For example, the user's unique identification key management unit 420 may be configured to generate a user's unique identification key for each user, and store and manage the user's unique identification key in an identification key DB 30 by matching the user's unique identification key to the user information in the customer DB 20.

The user's unique identification key may be sequentially assigned as the user inputs personal information in the shared service management server 400 and joins as a member, or may be generated based on user's unique information, for example, a user's unique password, a cellular phone number, or a serial code unique to the user terminal.

Although it has been described as an example that the user's unique identification key management unit 420 according to an embodiment of the present invention stores and manages the user's unique identification key in the identification key DB 30, the present invention is not limited thereto, and it may be configured to manage the user's unique identification key in the customer DB 20 together with other information only in the case of a user.

The shared object information management unit 430 is configured to manage product group information according to major, medium, and small categories to which the shared object belongs, and information the cost according to the period of using the shared object register by the operator terminal 200, and to store and manage information on the availability of the shared object according to operation of the system, information on the current use state, and the like in a shared object DB 40.

In addition, the shared object information management unit 430 is configured to store the production module identification key of the smart lock module 330 included in the shared object 300 to identify and manage the registered shared object through the production module identification key. For example, the shared object information management unit 430 may be configured to store and manage the production module identification key in the identification key DB 30 by matching the production module identification key to the shared object information in the shared object DB 40. The production module identification key may be serial number information of a microcontroller unit (MCU) of the smart lock module 330.

On the other hand, although it has been described as an example that the shared object information management unit 430 according to an embodiment of the present invention stores and manages the production module identification key in the identification key DB 30, it is not limited thereto, and the shared object information management unit 430 may be configured to manage the production module identification key together with information on the shared object in the shared object DB 40.

The payment processing unit 440 is configured to communicate with a server of a payment agency when there is a request from the user to make a payment for the period of using the selected shared object. The payment agency server may be, for example, a server of a card company, a cellular phone bill, or the like, or a server of a separate affiliated communication company. Through the payment processing unit 440, the user may make a payment for each shared item or for each designated period of using the same shared item, or may collectively make a payment for long-term use. Alternatively, the user may prepay using points that can be used in the shared service management system 1000 and consume the points in using the service.

For example, when there is a request for authentication or payment from the user terminal 100 in cooperation with a payment agency, the payment processing unit 440 transmits authentication or payment information to the server of the payment agency through a client program, which is linked to the server of the payment agency, an API, and the like so that the server of the payment agency may perform an authentication or payment process. When the authentication or payment process is completed, authentication or payment information, such as the customer's identification code (user's unique identification key), a shared object identification code (production module identification key), a payment amount, a payment time, and the like, is stored in the payment agency server. The payment processing unit 440 receives an authentication or payment success signal, and stores the same authentication or payment information in the customer DB 20 or a separate payment DB.

The payment processing unit 440 according to an embodiment of the present invention may perform a payment process in the process of selecting a shared object and a period of using the shared object and being allowed to use the shared object by the user, or when the user attempts to access or use the shared object through short-range communication with the smart lock module of the shared object using the user terminal after the user is allowed to use the shared object, the payment processing unit 440 may perform a payment process in the process of confirming whether the user matches.

The use approval unit 450 is configured to receives, when a payment success signal is received from the payment agency server through a payment process in the payment processing unit 440, the payment success signal, and allow the user who has made the payment to use the shared object, which is a payment target. The use approval unit 450 is configured to manage, when the user is allowed to use the shared object, the identification key of the shared object that the user has applied for, e.g., the production module identification key of the smart lock module included in the shared object, and the user's unique identification key of the user by matching them each other. Accordingly, when the user attempts to access or use the shared material thereafter, the use approval unit 450 may determine whether the user matches based on the information.

On the other hand, systematically, in the case where the consent or approval of the operator, who has registered the shared object, is required to allow the user to use the shared object, the use approval unit 450 may be designed to transmit the payment success signal to the operator terminal 200 of the operator who has registered the shared object when the payment success signal is received, and finally allow the user to use the shared object when the operator approves to use.

However, the present invention is not limited thereto, and prior approval of the operator may be required in the process before the user makes a payment. In this case, when the user applies for using a shared object and a period of using the shard object, the use approval unit 450 may transmit the user's application information to the operator terminal 200 of the operator who has registered the shared object, and proceed in a way of processing a payment when a prior approval is made by the operator.

In addition, the use approval unit 450 is configured to determine, when the user attempts to access or use the shared object 300 through the user terminal 100, whether the user is a user allowed to use, and allow the user to use the shared object.

Specifically, when the user attempts to access or use the shared object 300 through the user terminal 100, the user terminal 100 transmits the user's unique identification key to the smart lock module 330 of the shared object 300 through short-range communication, and the smart lock module 330 transmits the production module identification key, which is a unique identification key of the smart lock module 330, together with the user's unique identification key, to the shared service management server 400 through the network 10. Thereafter, the use approval unit 450 identifies the shared object that the user has attempted to access or use through the production module identification key, and determines whether the current user is a user allowed to use the shared object, i.e., whether the user matches. Thereafter, the use approval unit 450 transmits approval of using the shared object to the smart lock module 330 when matching of the user is confirmed.

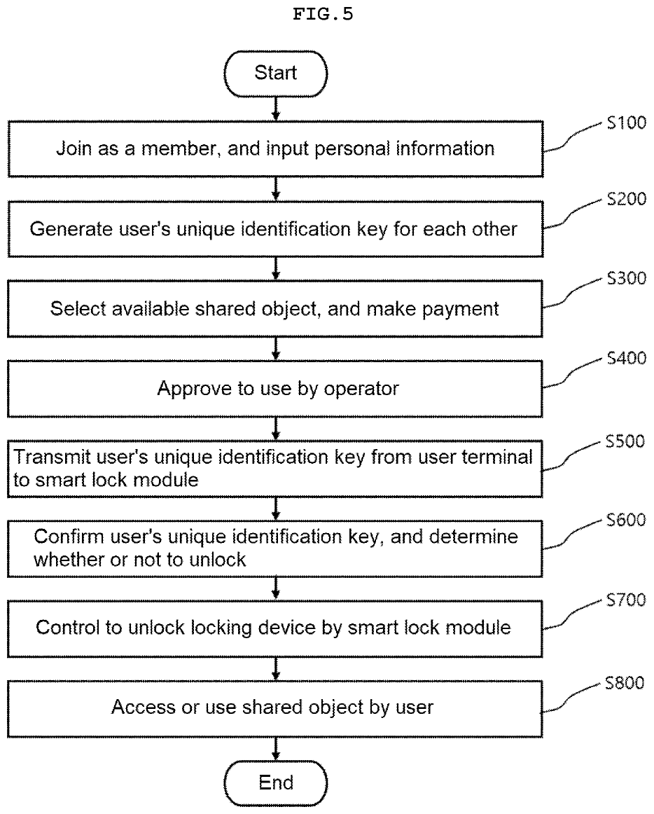

Hereinafter, a process of using a shared service by a user through the shared service management system will be described with reference to FIG. 5.

FIG. 5 is a flowchart illustrating a process of using a shared service by a user through a shared service management system according to an embodiment of the present invention.

Referring to FIG. 5, first, a user accesses the shared service management server 400 through the user terminal 100, joins as a member, and inputs personal information, such as an ID, password, and the like, in order to use a shared service provided by the shared service management system 1000 (S100).

Then, the shared service management server 400 generates a user's unique identification key for each user (S200). For example, the shared service management server 400 may be configured to generate a user's unique identification key for each user, and store and manage the user's unique identification key by matching the user's unique identification key to the user information. The user's unique identification key may be sequentially assigned as the user inputs personal information in the shared service management server 400 and joins as a member, or may be generated based on user's unique information, for example, an ID, a password, a user's unique password, a cellular phone number, or a serial code unique to the user terminal.

Thereafter, the user accesses the shared service management server 400, searches for shared objects that meet his or her desired conditions, selects an available shared object, and makes a payment for the period of using the shared object (S300).

When the payment is successfully made, the shared service management server 400 is configured to allow the user who has made the payment to use the shared object, which is a payment target (S400). On the other hand, systematically, in the case where the consent or approval of the operator, who has registered the shared object, is required to allow the user to use the shared object, the shared service management server 400 may be designed to inform success of payment to the operator terminal 200 of the operator who has registered the shared object when the payment is successfully made, and finally allow the user to use the shared object when the operator approves the user to use.

Thereafter, when the user attempts to access or use the shared object 300 through the user terminal 100, the user terminal 100 transmits the user's unique identification key to the smart lock module 330 of the shared object 300 through short-range communication (S500). Then, the smart lock module 330 transmits the production module identification key, which is a unique identification key of the smart lock module 330, together with the user's unique identification key, to the shared service management server 400 through the network 10.

The shared service management server 400 identifies a shared object that the user has attempted to access or use through the production module identification key, and determines whether the current user is a user allowed to use the shared object, i.e., whether the user matches, through the user's unique identification key (S600). That is, the shared service management server 400 determines whether or not to unlock. Accordingly, the shared service management server 400 transmits approval of using the shared object to the smart lock module 330 when matching of the user is confirmed.

The smart lock module 330 controls to unlock the locking device 310 when the user is confirmed as a user allowed to use according to whether the user matches that is received from the shared service management server 400 (S700). In addition, alternatively, it is configured to maintain the locked state of the locking device 310 when the user is not allowed to use. Thereafter, when the locking device 310 is unlocked, the user may access and use the shared object (S800).

That is, since a user may use at least one shared object by using his or her own identification key, rather than using a unique identification key provided for each shared object, the system 100 for managing shared services through registration and authentication of a user's unique identification key according to the present invention may provide users with convenience as a user may access various types of shared objects only by joining one platform, and simultaneously use a plurality of shared objects operated by different operation subjects by using one user's unique identification key without a separate information registration process.

Although it has been described above with reference to a preferred embodiment of the present invention, those skilled in the art or those having ordinary knowledge in the art may understand that the present invention may be diversely changed and modified without departing from the spirit and scope of the present invention described below in the claims.

1. A shared service management system that allows a user to use a plurality of shared services using his or her own user's unique identification key, the system comprising:
a plurality of operator terminals of different operation subjects, for registering at least one shared object managed by different shared services;
a user terminal that allows a user to apply for using a shared object and a period of using the shared object;
at least one shared object that includes a locking device for restricting access or use of the user, and a smart lock module configured to receive a user's unique identification key of the user from the user terminal through short-range communication and unlock the locking device to be independent from the locking device; and
a shared service management server configured to register data on the shared object according to the user's application for using the shared object and the user's unique identification key by matching them each other, receive the user's unique identification key, which is received from the user terminal, from the smart lock module through the network, when the user attempts to access or use the shared object that the user has applied for through the user terminal, determine whether the corresponding user is a user allowed to use based on the user's unique identification key, and transmit a user matching signal to the smart lock module based on a result of the determination, wherein
the smart lock module is configured to control locking and unlocking of the locking device based on the user matching signal of the shared service management server, and
the data on the shared object is a serial number of a microcontroller (MCU) of the smart lock module, and
the user's unique identification key is generated based on user's unique information in the shared service management server, and
a plurality of shared services operated by different operation subjects may be used through the user's unique identification key.

2. The system according to claim 1, wherein when the user applies for using a specific shared object, the shared service management server registers data on the specific shared object and the user's unique identification key of the user by matching them each other on the premise of approval of the operator who provides a sharing service for the specific shared object.

3. The system according to claim 1, wherein the short-range communication is at least one among RFID, NFC, and Bluetooth.

4. The system according to claim 1, wherein the smart lock module notifies, based on the user matching signal, whether or not the user matches to the user who attempts to access or use the shared object using the user terminal.

5. The system according to claim 1, wherein the user's unique identification key is generated based on at least one among a unique password of the user and a serial code of the user terminal.

6. The system according to claim 1, wherein the smart lock module is implemented as a Raspberry Pi.

7. The system according to claim 1, wherein the smart lock module is designed to be compatible with the locking device of the shared object, and is coupled to the locking device to lock or unlock the locking device.
